(19) United States
(12) Patent Application Publication
(10) Pub. No.: US 2012/0239759 A1
(43) Pub. Date: Sep. 20, 2012

(54) MOBILE DEVICE, STORAGE MEDIUM AND METHOD FOR PROCESSING EMAILS OF THE MOBILE DEVICE

(75) Inventor: JIE SUN, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/327,776

(22) Filed: Dec. 16, 2011

(30) Foreign Application Priority Data
Mar. 18, 2011 (CN) 201110066146.2

(51) Int. Cl. G06F 15/16

(52) U.S. Cl. 709/206

(57) ABSTRACT

In a method for processing an email transmitted between a first mobile device and a second mobile device, email content of the first mobile device are packed to be an email package with an Object Push Profile (OPP) format identified by a first communication module of the first mobile device. The method searches for a second communication module of a second device using the first communication module. If the first communication module matches the second mobile BLUETOOTH, a connection between the first communication module and the second communication module is established. If the second mobile device agrees to receive the email package, the method prompts the second mobile device to receive the email package, and transmits the email package through the first communication module to the second communication module.

### BACKGROUND

1. Technical Field

Embodiments of the present disclosure relate to email systems and methods, and more particularly to a mobile device, storage medium and method for processing emails of the mobile device.

2. Description of Related Art

A BLUETOOTH and email functions of a mobile device (e.g. a mobile phone) provide an important means of communication for users. The BLUETOOTH function is technology for data exchanging over short distances (e.g. using short wavelength radio transmissions in the ISM band from 2400-2480 MHz) between two or more mobile devices. However, the BLUETOOTH function of the mobile device is restricted to transferring voice data, image files, and MP3 files for free, for example. Emails from the mobile device must be transmitted and received based on a Code Division Multiple Access (CDMA) network or a General Packet Radio Service (GPRS) network. The transmission and reception of the emails may generate network congestion and cost. Free emails cannot be enjoyed conveniently.

### BRIEF DESCRIPTION OF THE DRAWINGS

FIG. 1 is a block diagram of one embodiment of a first mobile device and a second mobile device including an email processing system.

FIG. 2 is a block diagram of function modules of the email processing system included in the first and second mobile devices of FIG. 1.

FIG. 3 is a flowchart of one embodiment of an email processing method for transmitting an email from the first mobile device of FIG. 1.

FIG. 4 is a flowchart of one embodiment of an email processing method for receiving an email by the second mobile device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

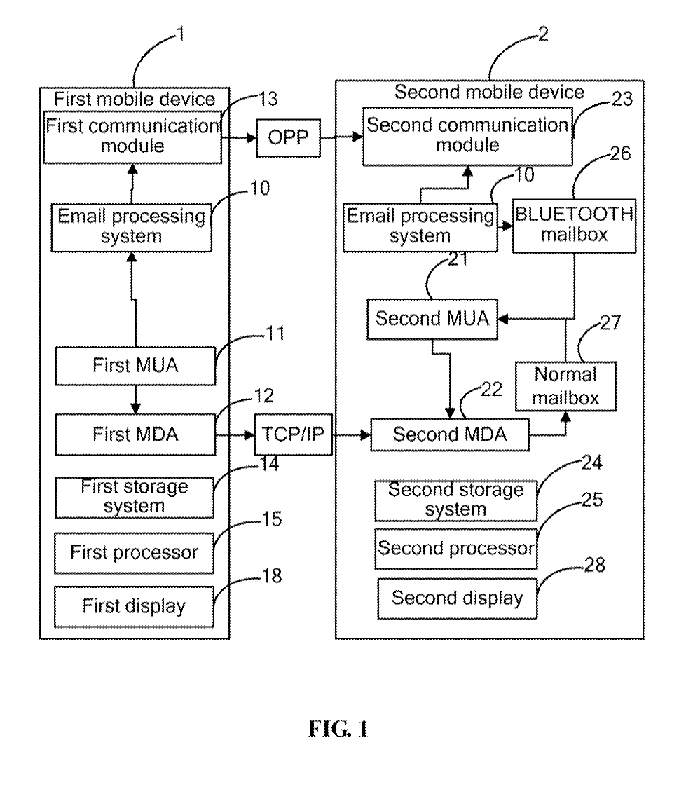

FIG. 1 is a block diagram of one embodiment of a first mobile device 1 and a second mobile device 2 including an email processing system 10. In the embodiment, the email processing system 10 is included in both of the first mobile device 1 and the second mobile device 2, and implements an email function for the two mobile devices 1,2. In order to describe conveniently, in the embodiment, the first mobile device 1 is considered as a transmitter for transmitting emails from the first mobile device 1, and the second mobile device 2 is considered as a receiver for receiving the emails from the first mobile device 1.

In another embodiment, the first mobile device 1 can be the receiver, and the second mobile device 2 can be the transmitter. The first mobile device 1 includes a first communication module 13, and the second mobile device 2 includes a second communication module 23. In one embodiment, the communication module may be a BLUETOOTH module. The email processing system 10 may transmit and receive the emails between the first mobile device 1 and the second mobile device 2 through the first communication module 13 and the second communication module 23.

The first mobile device 1 further includes a first mail user agent (MUA) 11 and a first mail delivery agent (MDA) 12. The second mobile device 2 further includes a second MUA 21 and a second MDA 22. The first MUA 11 or the second MUA 21 is used to manage the email, such as editing, transmitting or reading the email, for example. The first MDA 12 or the second MDA 22 is responsible for delivery of the email messages to a mailbox. The first MDA 12 and the second MAD 22 may transmit and receive the emails according to a Transmission Control Protocol/Internet Protocol (TCP/IP). As the receiver, the second mobile device 2 further includes a BLUETOOTH mailbox 26 and a normal mailbox 27. The first mobile device 1 may also include the BLUETOOTH mailbox and the normal mailbox (not shown in FIG. 1). In one embodiment, the email processing system 10 may transmit and receive the emails according to an Object Push Profile (OPP) protocol of a BLUETOOTH system. If the first mobile device 1 transmits an email through the first communication module 13, the second mobile device 2 receives the email through the second communication module 23 and stores the email in the BLUETOOTH mailbox 26. If the first mobile device 1 transmits the email through the first MDA 12, the second mobile device 2 receives the email through the second MDA 22 and stores the email into the normal mailbox 27.

The first mobile device 1 further includes a first storage system 14, a first processor 15 and a first display 18. The second mobile device 2 includes a second storage system 24, a second processor 25 and a second display 28. The first display 18 and the second display 28 display visual data. The first and second storage systems 14 and 24 store data for their respective devices. The first storage system 14 or the second storage system 24 may be a memory, an external storage card, such as a smart media card, or a secure digital card. Both the first and second processors 15 and 25 execute one or more computerized codes and other applications for their respective devices, to provide the functions of the email processing system 10.

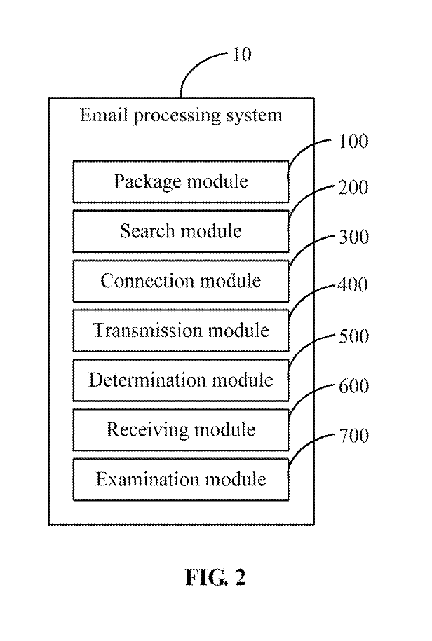

FIG. 2 is a block diagram of function modules of the email processing system 10 included in the mobile device 1 and in the second mobile device 2 of FIG. 1. In the embodiment, the email processing system 10 may include a package module 100, a search module 200, a connection module 300, a transmission module 400, a determination module 500, a receiving module 600 and an examination module 700. The modules 100, 200, 300, 400, 500, 600 and 700 comprise computerized codes in the form of one or more programs that may be stored in each of the first storage system 14 and the second storage system 24. The computerized code includes instructions that are executed by the first processor 15 or by the second processor 25 to provide functions for the modules. In the embodiment, if the first mobile device 1 is the transmitter, the first mobile device 1 runs the modules 100, 200, 300 and 400 to transmit the email. If the second mobile device is the receiver, the second mobile device 2 runs the modules 500, 600, and 700 to receive the email. Details of these operations follow.

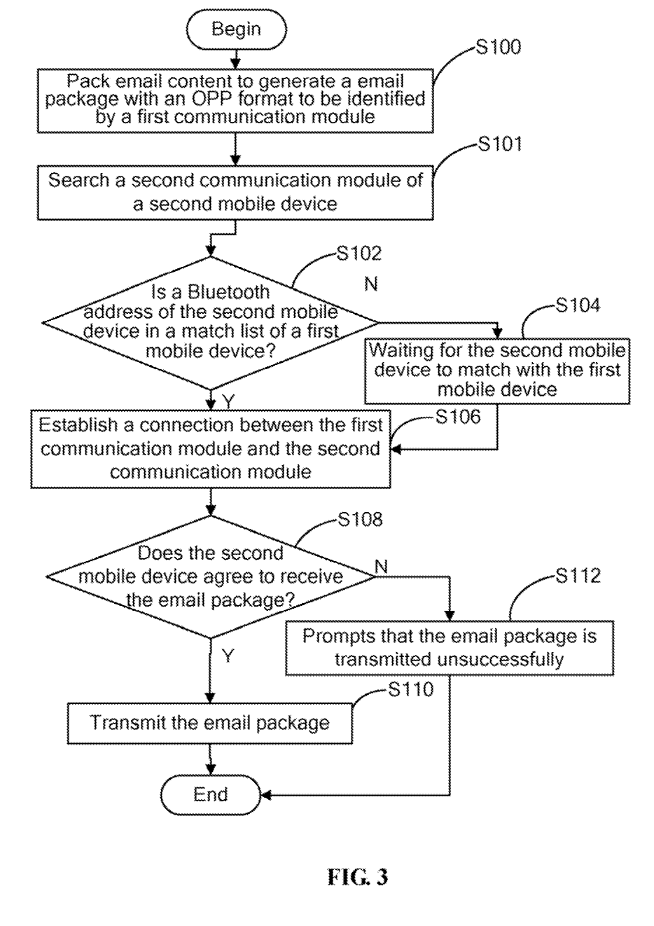

FIG. 3 is a flowchart of one embodiment of an email processing method for transmitting an email from the first mobile device 1 of FIG. 1. Depending on the embodiment, additional blocks may be added, others deleted, and the ordering of the blocks may be changed.

In block S100, the package module 100 packs email content of the first mobile device 1 to generate an email package with an OPP format, and transmits the email package to the second mobile device 2 through the first communication module 13. The email content is in accordance with an internet message format which is a normal format including a header and a body in the email content. For example, the internet message format may be a RFC2822 format. The OPP format is a standard format that can be identified by the first communication module 13 and the second communication module 23. In one embodiment, the package module 100 may first verify whether a header of the email content including an originator, a recipient, a transmission time, any carbon copy address(es), and a message subject. If the header is verified successfully, the package module 100 further verifies whether characters, a coding mode, a format and a signature of a body of the email content conform to a predetermined specification. If the body of the email content is verified successfully, the package module 100 adds a BLUETOOTH address of the recipients (e.g. the second mobile device 2), and registration, match and connection information of the first communication module 13 to the email content to constitute the email package of the first mobile device 1. Users may manage the email content through the first MUA 11.

In block S101, the search module 200 searches for the second communication module 23 of the second mobile device 2 using the first communication module 13. In one embodiment, the search module 200 may determine whether the second communication module 23 is in a list of discoverable devices, and the devices within a predetermined coverage area (e.g., within 10 square meters of the first mobile device 1) may be searched by the first communication module 13. The search module 200 searches for the second communication module 23 according to the BLUETOOTH address of the second mobile device 2.

In block S102, the connection module 300 reads a match list of the first mobile device 1, and determines whether the BLUETOOTH address of the second mobile device 2 is in the match list. The match list records BLUETOOTH addresses of mobile devices that have matched the first mobile device 1 using the first communication module 13. If the BLUETOOTH address of the second mobile device 2 is in the match list, block S106 is implemented. If the BLUETOOTH address of the second mobile device 2 is not in the match list, that is, the first mobile device 1 and the second mobile device 2 have not matched, block S104 is implemented.

In block S104, the connection module 300 prompts the first mobile device 1 for matching the second mobile device 2 on the first display 18 through the first communication module 13 and the second communication module 23, and waits for first mobile device 1 matching the second mobile device 2.

If the first mobile device 1 can and does match the second mobile device 2, in block S106, the connection module 300 establishes a connection between the first communication module 13 and the second communication module 23. Within any predetermined given time (e.g. 100 seconds), data can be transferred between the first mobile device 1 and the second mobile device 2.

In block S108, the transmission module 400 prompts the second mobile device 2 to receive the email package or not on the second display 28. For example, the transmission module 300 can transmit a message of “receiving the email or not?”, and offer the two choices “yes” or “no” to the second mobile device 2, and wait for the choice from the second mobile device 2. If the second mobile device 2 does not agree to receive the email package (e.g., the first mobile device 1 receives “no” as the choice made), block S112 is implemented. If the second mobile device 2 agrees to receive the email package (e.g. the first mobile device 1 receives “yes” as the choice made), block S110 is implemented.

In block S110, the transmission module 400 transmits the email package through the first communication module 13 and the second communication module 23 according to the OPP protocol.

In block S112, the transmission module 400 indicates to the first mobile device 1 that the email package has been transmitted unsuccessfully on the first display 18, such as displaying a message of “transmission failure”.

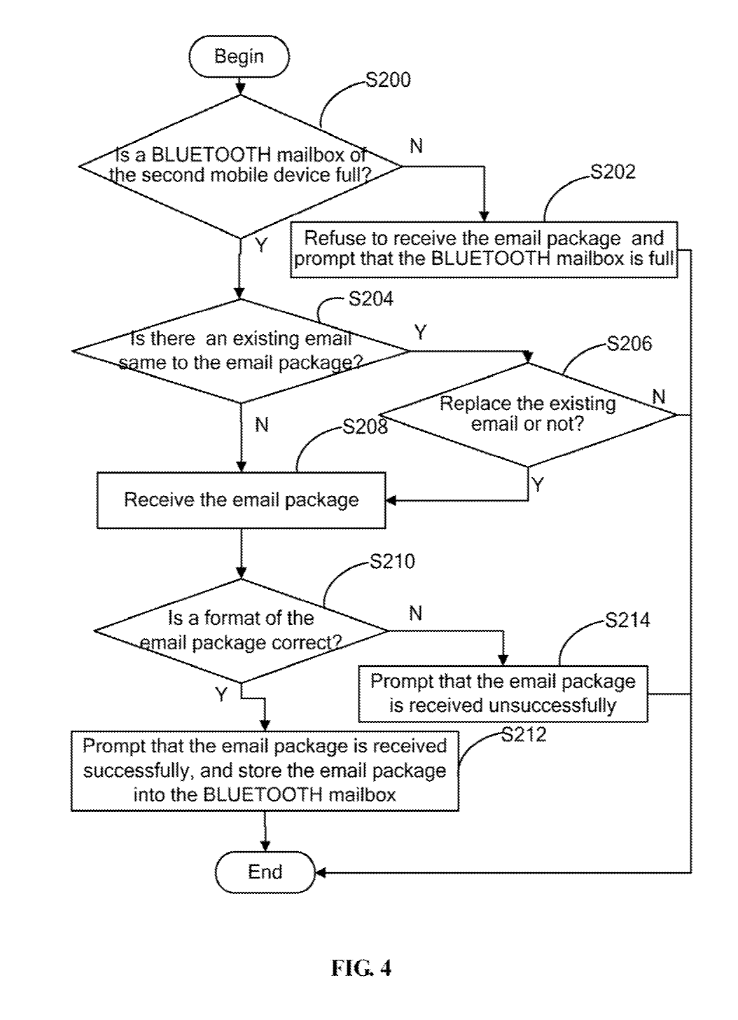

FIG. 4 is a flowchart of one embodiment of an email processing method for receiving an email by the second mobile device 1 of FIG. 1. Depending on the embodiment, additional blocks may be added, others deleted, and the ordering of the blocks may be changed.

In block S200, the determination module 500 determines whether the BLUETOOTH mailbox 26 is full. If the BLUETOOTH mailbox 26 is full, block S202 is implemented. If the BLUETOOTH mailbox 26 is not full, block S204 is implemented.

In block S202, the determination module 500 refuses to receive the email package, and prompts the second mobile device 2 that the BLUETOOTH mailbox 26 is full on the second display 28.

In block S204, the determination module 500 determines whether there is an existing email in the BLUETOOTH mailbox 26 with the same subject of the email package. If there is the exiting email is found in the BLUETOOTH mailbox 26, block S206 is implemented. If no existing email is found in the BLUETOOTH mailbox 26, block S208 is implemented.

In block S206, the determination module 500 prompts the second mobile device 2 for replacing the existing email or not on the second display 28. For example, the determination module 500 may display a message of “replace the existing email?” by selecting either “yes” or “no” on the second mobile device 2, and wait for a selection by the second mobile device 2. If the second mobile device 2 does replace the existing email, block S208 is implemented. If the second mobile device 2 chooses not to replace the existing email, the procedure ends.

In block S208, the receiving module 600 receives the email package sent from the first mobile device 1 through the second communication module 23 according to the OPP protocol.

In block S210, the examination module 700 examines whether a format of the email package is correct. In one embodiment, the examination module 700 may examine whether the email content of the email package conforms to the internet message format. If the email content of the email package does conform to the internet message format, that is to say the format of the email package is correct, block S212 is implemented. If the email content of the email package does not conform to the internet message format, block S214 is implemented.

In block S212, the examination module 700 prompts the second mobile device 2 that the email package has been received successfully on the second display 28, and stores the email package in the BLUETOOTH mailbox 26. The users may read the email at any time by unpacking the email package in the BLUETOOTH mailbox 26 through the second MUA 21.

In block S214, the examination module 700 prompts the second mobile device 2 that the email package is received unsuccessfully on the second display 28, such as displaying a message “failure to receive email” on the second mobile device 2.

All of the processes described above may be embodied in, and fully automated via, functional code modules executed by one or more general purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A method for processing an email transmitted between a first mobile device and a second mobile device, the method comprising:
packing email content of the email to generate an email package with an Object Push Profile (OPP) format that is identified by a first communication module of the first mobile device;
searching for a second communication module of a second mobile device using the first communication module;
reading a match list recorded devices that matched the first mobile device according to the first communication module, and establishing a connection between the first communication module and the second communication module if the first mobile device matches the second the mobile device;
prompting the second mobile device for receiving the email package of the first mobile device on a second display of the second mobile device; and
transmitting the email package through the first communication module to the second communication module if the second mobile device agrees to receive the email package.

2. The method as claimed in claim 1, wherein the first communication module is a first BLUETOOTH module and the second communication module is a second BLUETOOTH module.

3. The method as claimed in claim 2, further comprising:
determining whether a BLUETOOTH mailbox of the second mobile device is full in response to the second mobile device receiving the email package;
refusing to receive the email package if the BLUETOOTH mailbox is full, and prompting the second mobile device that the BLUETOOTH mailbox is full on the second display;
determining whether there is an existing email with a same subject of the email package in the BLUETOOTH mailbox;
prompting the second mobile device whether to replace the existing email or not on the second display, if there is the existing email in the BLUETOOTH mailbox;
receiving the email package using the second communication module, if the existing email is to be replaced.

4. The method as claimed in claim 3, further comprising:
examining whether a format of the email package is correct by checking whether the email content of the email package conforms to a predetermined internet message format;
prompting the second mobile device that the email package is received successfully on the second display, and storing the email package in the BLUETOOTH mailbox, if the format of the email package is correct; or
prompting the second mobile device that the email package is received unsuccessfully on the second display, if the format of the email package is incorrect.

5. The method as claimed in claim 2, wherein the email package is generated by steps of:
verifying whether a header of the email content including an originator, a recipient, a transmission time, a carbon copy address, and a subject;
verifying whether characters, a coding mode, a format and a signature of a body of the email content conform to a predetermined specification, if the header is verified successfully;
adding a BLUETOOTH address of the recipients, and registration, match, connection information of the first communication module to the email content to constitute the email package of the mobile device.

6. The method as claimed in claim 2, wherein the second communication module is searched by steps of:
determining whether the second communication module is in a list of in the first mobile device, the list including other communication modules being searched by the first communication module in a predetermined coverage area; and
searching for the second communication module according to a BLUETOOTH address of the second mobile device.

7. A non-transitory storage medium storing a set of instructions, the set of instructions capable of being executed by a first mobile device, causes the first mobile device to perform a method for processing an email transmitted between the first mobile device and a second mobile device, the method comprising:
packing email content of the email to generate an email package with an Object Push Profile (OPP) format that is identified by a first communication module of the first mobile device;
searching for a second communication module of a second mobile device using the first communication module;
reading a match list recorded devices that matched the first mobile device using the first communication module, and establishing a connection between the first communication module and the second communication module if the first mobile device matches the second the mobile device;
prompting the second mobile device for receiving the email package of the first mobile device on a second display of the second mobile device; and
transmitting the email package through the first communication module to the second communication module if the second mobile device agrees to receive the email package.

8. The storage medium as claimed in claim 7, wherein the first communication module is a first BLUETOOTH module and the second communication module is a second BLUETOOTH module.

9. The storage medium as claimed in claim 8, wherein the method further comprising:
determining whether a BLUETOOTH mailbox of the second mobile device is full in response to the second mobile device receiving the email package;
refusing to receive the email package if the BLUETOOTH mailbox is full, and prompting the second mobile device that the BLUETOOTH mailbox is full on the second display;
determining whether there is an existing email with a same subject of the email package in the BLUETOOTH mailbox;
prompting the second mobile device whether to replace the existing email or not on the second display, if there is the existing email in the BLUETOOTH mailbox;
receiving the email package using the second communication module, if the existing email is to be replaced.

10. The storage medium as claimed in claim 8, wherein the method further comprising:
examining whether a format of the email package is correct according to the email content of the email package conforming to a predetermined internet message format;
prompting the second mobile device that the email package is received successfully on the second display and stores the email package in the BLUETOOTH mailbox, upon the condition that the format of the email package is correct; or
prompting the mobile device that the email package is received unsuccessfully on the second display, upon the condition that the format of the email package is incorrect.

11. The storage medium as claimed in claim 7, wherein the email package is generated by steps of:
verifying whether a header of the email content including an originator, a recipients, a transmission time, a carbon copy address, and a subject;
verifying whether characters, a coding mode, a format and a signature of a body of the email content conform to a predetermined specification, upon the condition that the header is verified successfully;
adding a BLUETOOTH address of the recipients, and registration, match, connection information of the first communication module to the email content to constitute the email package of the mobile device.

12. The storage medium as claimed in claim 7, wherein the second communication module is searched by steps of:
determining whether the second communication module is in a list of in the first mobile device, the list comprising other communication modules being searched by the first communication module in a predetermined coverage area; and
searching for the second communication module according to a BLUETOOTH address of the second mobile device.

13. A mobile device, comprising:
a first communication module;
a first display;
a storage system and at least one processor; and
one or more programs that are stored in the storage system and executed by the at least one processor, the one or more programs comprising:
a packaging module operable to pack an email content of the mobile device to generate an email package with an Object Push Profile (OPP) format that is identified by a first communication module of the mobile device;
a searching module operable to search for a second communication module of a receiver device using the first communication module;
a connection module operable to read reading a match list recorded devices that matched the mobile device using the first communication module, and establish a connection between the first communication module and the second communication module if the mobile device matches the receiver device;
a transmission module operable to prompt the receiver device to receive the email package sent from the mobile device on a second display of the receiver device, and transmit the email package through the first communication module to the second communication module if the receiver device agrees to receive the email package.

14. The mobile device as claimed in claim 13, wherein the first communication module is a first BLUETOOTH module and the second communication module is a second BLUETOOTH module.

15. The mobile device as claimed in claim 14, wherein the one or more programs further comprises:
a determination module operable to determine whether a BLUETOOTH mailbox of the receiver device is full, refuse to receive the email package if the BLUETOOTH mailbox is full, prompt the receiver device that the BLUETOOTH mailbox is full on the second display, and determining whether there is an existing email with a same subject of the email package in the BLUETOOTH mailbox, and prompt the receiver device whether to replace the existing email or not on the second display, if there is the existing email in the BLUETOOTH mailbox; and
a receiving operable to receive the email package using the second communication module, if the existing email is to be replaced.

16. The mobile device as claimed in claim 15, wherein the one or more programs further comprise:
an examination module operable to examine whether a format of the email package is correct by checking whether the email content of the email package conforms to a predetermined internet message format, and prompt the receiver device that the email package is received successfully and store the email package in the BLUETOOTH mailbox if the format of the email package is correct, or prompt the receiver device that the email package is received unsuccessfully if the format of the email package is incorrect.

17. The mobile device as claimed in claim 14, wherein the email package is generated by:
verifying whether a header of the email content including an originator, a recipients, a transmission time, a carbon copy address, and a subject;
verifying whether characters, a coding mode, a format and a signature of a body of the email content conform to a predetermined specification, upon the condition that the header is verified successfully;
adding a BLUETOOTH address of the recipients, and registration, match, connection information of the first communication module to the email content to constitute the email package of the mobile device.

18. The mobile device as claimed in claim 13, wherein the second communication module is searched by:
determining whether the second communication module is in a list of the mobile device, the list comprising other communication modules being searched by the first communication module in a predetermined coverage area; and
searching for the second communication module according to a BLUETOOTH address of the receiver device.
